(19) United States
(12) Patent Application Publication
(10) Pub. No.: US 2004/0162767 A1
(43) Pub. Date: Aug. 19, 2004

(54) Interactive logistics management method

(76) Inventor: Chih-Hung Chien, Taoyuan (TW)

Correspondence Address: BIRCH STEWART KOLASCH & BIRCH, PO BOX 747, FALLS CHURCH, VA, 22040-0747, US

(21) Appl. No.: 10/360,618

(22) Filed: Feb. 10, 2003

(51) Int. Cl. G06F 17/60

(52) U.S. Cl. 705/28

(57) ABSTRACT

An interactive logistics management method is disclosed to build multiple Web sites and employs lot ids to connect the information in these Web sites to provide the basis for logistics handling, tracking and management.

### BACKGROUND OF THE INVENTION

1. Field of Invention

The invention is related to logistics control management, and especially an interactive logistics control method cooperating with external enterprises.

2. Related Art

Due to the rapid advance of information technology in recent years, E-commerce has become a new trend of Internet applications, making relationships between enterprises closer through integration via the Internet. Logistics between enterprises has become an important issue, and all enterprises endeavor to improve their logistics management in order to improve their competitiveness. Logistics management has also become an important strategy of the enterprises, including order processing, distribution, warehousing, inventory control, packaging, materials transportation and refundment.

For materials transportation and tracking management, if the distance of transportation increases, the difficulty for manufacturers to control these materials also increases. In the past, materials management required the personnel of providers, logistics companies (external), purchasing departments and materials planning departments (internal) to confirm with one another by telephone or fax. In addition, when the materials are shipped, auditors check these materials again. Such complex processes cannot reduce cost, and increase the probability of error in information delivery.

Therefore, providing an operating model to integrate the operations of providers, transporters and manufacturers to make these enterprises cooperatively plan and operate the value-added activities of logistics is an important issue of enterprises, and it requires a simple and convenient solution.

### SUMMARY OF THE INVENTION

To overcome the above problems, an interactive logistics management method is proposed by the invention to make the providers, transporters and manufacturers able to connect their Web sites by a unique lot id for each product, to provide information transparency by setting up check points in these Web sites, and to provide the basis of logistics management and tracking by storing the information of goods and updating the Web sites automatically.

The process of the interactive logistics management method proposed by the invention is as follows. When shipping goods, the providers immediately log onto the provision Web site to record the shipping information of the goods. When receiving the goods, the distribution centers log onto the distribution Web site, update the status of these goods, and transfer the goods to the logistics companies. When receiving the shipping notifications of goods from the enterprises' external Web sites, the logistics companies assemble the goods and then ship them. When receiving the goods, the manufacturers log onto the manufacture Web site and update the status of these goods. The system automatically detects the latest status, and updates the provider, distribution and manufacture Web sites to keep consistency among these Web sites. In addition, the system informs the providers, distribution centers and manufacturers of the latest status of these goods.

### BRIEF DESCRIPTION OF THE DRAWINGS

The invention will become more fully understood from the detailed description given hereinbelow illustration only, and thus are not limitative of the present invention, and wherein:

FIG. 1 is the architecture of the proposed interactive logistics management method.

FIG. 2 is the flowchart of the proposed interactive logistics management method.

### DETAILED DESCRIPTION OF THE INVENTION

The architecture of the logistics management method proposed by the invention contains three parties: providers, manufacturers and distributors. It builds multiple interactive Web sites for multi-party collaborative operations to combine Internet technology and physical logistics. This method uses lot ids to connect the information in these Web sites, and makes the related enterprises in the supply chain (including providers, shippers, manufacturers, buyers, forwarders, transporters, warehouse providers) able to effectively control the delivery information of goods and improve the related service quality and efficiency.

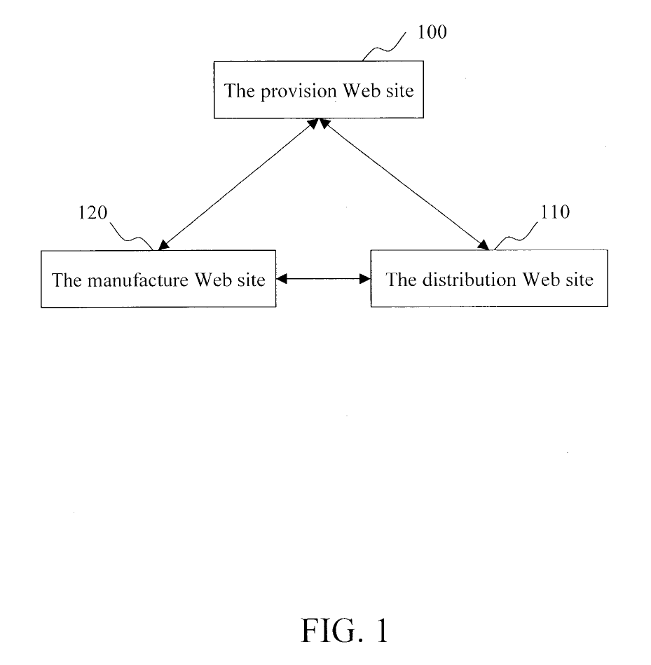

An example is used to describe the applicability of the invention. FIG. 1 shows the architecture of the interactive logistics management method proposed by the invention. The description of this architecture is as follows.

The proposed interactive logistics management method builds a provision Web site (Web-A) 100, distribution Web site (Web-B) 110 and manufacture Web site (Web-C) 120 in the provider, distributor and manufacturer respectively, and makes them able to immediately transmit logistics related information and data. The provider has to enter the product information into the provision Web site, and the provision Web site automatically connects to the distribution Web site to generate the transportation information that is the basis for the logistics companies and materials planning personnel to handle and track. The receivers get the information of goods before receiving and hence the processing time is reduced. The real-time transportation information is also provided by the connection between all Web sites.

When the provider makes sure that the goods have arrived from the provision Web site, the system updates immediately to keep the information of data flow and logistics consistent. It also makes these parties monitor the progress of production and the delivery status of logistics by the real-time communication mechanism built by related enterprises. The progress of projects can also be communicated and confirmed with related enterprises via the Internet. All related enterprises are always on-line and can monitor the process of jobs and the receipt status of goods collaboratively to achieve real-time logistics management.

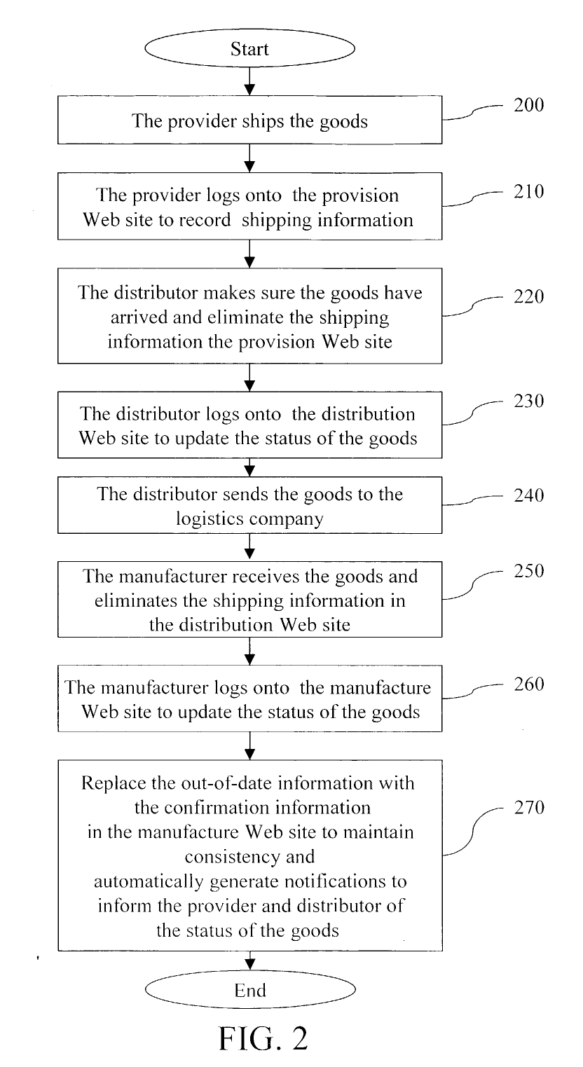

FIG. 2 shows the flowchart of the proposed interactive logistics management method. The description of the flowchart is as follows.

As the provider ships the goods (Step 200), s/he logs onto the provision Web site (Web-A) and records the shipping data. When the distributor receives the goods (Step 220), s/he eliminates the shipping information from the provision Web site, logs onto the distribution Web site (Web-B), updates the status of goods (Step 250) and sends the goods to the logistics company (Step 240). When the manufacturer receives the goods, s/he eliminates the shipping information from the distribution Web site, logs onto the manufacture Web site (Web-C) and updates the status of goods. In addition, the system uses the confirmation to update the data in the provision, distribution and manufacture Web sites to maintain consistency between them, and generate notifications automatically to inform the distributor of the status of goods (Step 270). After integration of the information of production management, shipping systems and logistics management systems and the material cost related information, analysis of quality and yield can be conducted to evaluate the cost and profit. All reports that used to be generated by massive labor are generated by the system automatically, and processing efficiency is hence improved. In addition, transmitting analytical results and abnormality alerts by the network reduces the processing time and used resources.

From the above description of the proposed interactive logistics management method, the advantages in actual applications are as follows:

In respect to internal logistics integration, due to informationization, this method makes the receiving and processing of orders more efficient, integrates the order shipping for collaborative delivery, and uses the warehouse space and system effectively.

In respect to external logistics integration, the proposed method keeps the logistics information in these parties consistent to achieve uniformity of distribution operations and warehouse management.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

What is claimed is:

1. An interactive logistics management method, for transmitting the distribution information among the providers, the delivers and the manufacturers, comprising the following steps:
the provider logging onto the provision Web site and recording the shipping data after shipping goods;
after the distributor receives the goods, the distributor logging onto the distribution Web site to eliminate the shipping data in the provision Web site, and update the status of goods, and then sending the goods to the logistics company;
after the manufacture receives the goods, the manufacturer logging onto the manufacture Web site to eliminate the shipping data from the distribution Web site and update the status of the goods; and
the system updating the out-of-date data in provision, distribution and manufacture Web sites by the confirmation in the manufacture Web site, and automatically generating notifications to inform the provider and distributor of the status of the goods.

2. The method of claim 1, wherein the provision Web site is a logistics Web site built in the provider.

3. The method of claim 1, wherein the distribution Web site is a logistics Web site built in the distributor.

4. The method of claim 1, wherein the manufacture Web site is a logistics Web site built in the manufacturer.

5. The method of claim 1, wherein the logistics company communicates with the provider, distributor or manufacturer by a transportation Web site.

6. The method of claim 1, wherein the Web system is an information management system integrating the provision, distribution and manufacture Web sites.

7. The method of claim 1, wherein the Web system monitors the status of the goods and will automatically update its content to keep the consistency of the said Web sites.
